(19) United States
(12) Patent Application Publication
(10) Pub. No.: US 2024/0286797 A1
(43) Pub. Date: Aug. 29, 2024

(54) Disposable Cup With Mixing Device

(71) Applicant: We-Can Ltd, Tel Aviv (IL)

(72) Inventor: Shay Kossovsky, Kfar-Hananya (IL)

(21) Appl. No.: 18/115,096

(22) Filed: Feb. 28, 2023

(51) Int. Cl. B65D 25/02; B01F 33/501

(52) U.S. Cl. CPC B65D 25/02; B01F 33/50111; B01F 2101/06

(57) ABSTRACT

A disposable beverage cup, including: a wall, in a form of a rolled foil, the wall having a lip on an upper end thereof and a bottom wall enclosing a lower end thereof; and a mixing device, attached to an inner surface of the wall; wherein at least a portion of the mixing device adapted to be removed from the assembly without causing fibers to be deposited into a beverage disposed therein.

### FIELD OF THE INVENTION

The present invention relates to a single-use/disposable cups and, more particularly, to a disposable cup with a mixing device attached to the inside of the cup.

### BACKGROUND OF THE INVENTION

According to worldwide surveys, there is an increasing trend in using disposable cups. The annual consumption of disposable cups in the USA stands at 23 billion. In addition, 65% of the Americans use a sweetener in their beverages.

A common means of mixing beverages in a disposable cup is a mixing device. The mixing device is also disposable. Common mixing devices are usually made of plastic, or from wood. The annual consumption of disposable mixing devices in the USA during 2010 was 15 billion devices.

U.S. Pat. No. 8,936,388 discloses a disposable cup with mixing device attached thereto. The document is incorporated in its entirety as if fully set forth herein.

### SUMMARY OF THE INVENTION

According to the present invention there is provided an assembly including: a disposable beverage cup, including: a wall, in a form of a rolled foil, the wall having a lip on an upper end thereof and a bottom wall enclosing a lower end thereof; and a mixing device, attached to an inner surface of the wall; wherein at least a portion of the mixing device adapted to be removed from the assembly without causing fibers to be deposited into a beverage disposed therein.

According to further features in preferred embodiments of the invention described below an adhesive layer is disposed between an anchor portion or portions of the mixing device and the inner surface of the wall, the adhesive layer adapted for allowing the mixing device to be detached from the inner wall without damaging the mixing device or the inner wall.

According to still further features in the described preferred embodiments the inner wall has a waterproof lining, and the waterproof lining is not damaged when the mixing device is detached from the inner wall.

According to still further features mixing device has a pop lock feature wherein a portion of a stem of the mixing device is adapted to deform when transitioning between an unlocked state and a locked state.

The pop lock feature includes score lines provided on the stem proximal an agitating portion of the mixing device, the score lines including two widthwise, convex, semi-circular score lines spaced apart from each other, the score lines facilitating movement between the unlocked state and the locked state upon receipt of downward vertical pressure, wherein in the unlocked state the tab juts above the lip of the wall and in the locked state the stem deforms along the score lines such that the portion of the stem is disposed between the spaced apart score lines is folded behind the agitating portion of the mixing device located at a distal end of the mixing device.

According to still further features the mixing device is a U-shaped stirrer. The U-shaped stirrer includes two elongated arms and an agitating portion linking lower ends of the arms, free upper ends of the two elongated arms are adapted to be held together by a user and used to stir the beverage after being detached from the cup.

According to still further features the mixing device includes a tab, a stem, and an agitating portion and wherein the stem is adapted to be torn away from the agitating portion without fibers being deposited in the beverage. According to still further features an axis of the stem is approximately perpendicular to a section of the agitating portion where the stem meets the agitating portion. According to still further features the section of the agitating portion where the stem meets the agitating portion is perforated.

According to still further features the axis of the stem is at an off-set angle relative to vertical arms of the agitating portion.

According to still further features a stem of the mixing device terminates at an off-center section of an agitating portion of the mixing device, wherein manipulation of the stem causes the agitation portion to effect a circular movement of fluid disposed in the cup. According to still further features the circular movement of the fluid reduces splashing.

According to another embodiment there is provided a disposable beverage cup, including: a wall, in a form of a rolled foil, the wall having a lip on an upper end thereof and a bottom wall enclosing a lower end of the wall; and a mixing device, said mixing device including: a stem having a tab disposed at an upper end thereof and an agitating portion disposed at a lower end thereof, the stem having an unlocked state wherein the tab juts out above the lip of the wall and a locked state wherein the tab does not jut out above the lip, wherein a portion of the stem is adapted to deform when transitioning between the unlocked state and the locked state upon receipt of a downward vertical pressure on the stem. The tab adapted to jut out above the wall so as to be held by two fingers of a user in a pincer grip and manipulated in at least a vertical direction, wherein score lines are provided on the stem, proximal the agitating portion; the score lines including two widthwise, convex, semi-circular score lines spaced apart from each other; the score lines facilitating movement between an unlocked state and a locked state, wherein in the unlocked state the tab juts above the lip of the wall and in the locked state the stem, upon receipt of downward vertical pressure, deforms along the score lines.

According to still further features the tab is adapted to fit through a drinking opening of a foldable lid or a disposable lid when the disposable lid is friction fitted on the lip of the wall.

According to still further features the agitating portion includes: a movable flap and at least one shoulder portion extending upwards from the movable flap, each of the at least one shoulder portion having an upper edge thereof adhered to the wall.

According to still further features the at least one shoulder portion includes two shoulder portions extending upwards from the movable flap on either side of the stem, and wherein upper edges of the two shoulder portions are adhered to the wall.

According to still further features a section defined between the score lines folds behind the movable flap when transitioning between the unlocked state and the locked state.

According to still further features the section defined between the score lines has a length at least equal to a height at which the tab juts out above the wall.

According to still further features further including a horizontal score line between the central section and the movable flap.

### BRIEF DESCRIPTION OF THE DRAWINGS

Various embodiments are herein described, by way of example only, with reference to the accompanying drawings, wherein:

FIG. 1 is a partial representation of a disposable cup 10 with an example embodiment of a stirrer shown exploded away from the sidewall of the cup to which it is attached;

FIG. 2 is a front view of the example embodiment of the stirrer;

FIG. 3 is a view of the stirrer of FIGS. 1 and 2 with arrows indicating direction of movement of the stem and corresponding movement of the stirring portion;

FIG. 4 is a partial view of cup 10 and stirrer 100 according to another embodiment;

FIG. 5A is an example embodiment of a disposable cup assembly with a detachable stirrer;

FIG. 5B is a view of the stirrer 500 after being detached;

FIG. 5C is a view of the stirrer 500 with arms placed together, where the tops of the arms overlap;

FIG. 6A is a view of a mixing device 600 which is adapted to be attached or adhered to the inside surface of a wall of a disposable cup;

FIG. 6B is a view of mixing device 600 with arrows 630 which depict an example path through which the liquid will flow when a user manipulates the mixing device by moving the tab in a vertical direction;

FIGS. 6C-6E are views of the mixing device 600 with arrows indicating the direction of movement of the tab and corresponding movement of the flap.

FIG. 6F is a view of the mixing device 600 with a perforation area 640 located at the meeting point between the stem and the arm;

FIG. 7 is an example embodiment of a mixing apparatus, according to another configuration of the invention.

### DESCRIPTION OF THE PREFERRED EMBODIMENTS

The principles and operation of a stirring apparatus/mixing device attached to a disposable cup according to the present invention may be better understood with reference to the drawings and the accompanying description.

Various terms are used interchangeably herein. The terms “stirrer”, “stirring apparatus” and variations thereof are used herein to denote a mixing device or an agitating apparatus. As such, the terms “mixing device”, “agitating apparatus”, “agitating member”, “stirrer” and variation thereof are all used interchangeably herein and are to be seen as having the plain meaning of a mixing device or agitating member.

The terms “mixing device” and “agitating apparatus” both encompass all methods of agitating liquid inside a cup. The term stirrer could be understood to only mean an apparatus for stirring a beverage e.g., using a circular motion. However, for the purposes of this document, the term stirrer, unless otherwise specifically described, should be understood to have the same meaning as a mixing device and/or an agitating apparatus.

### Pop Lock

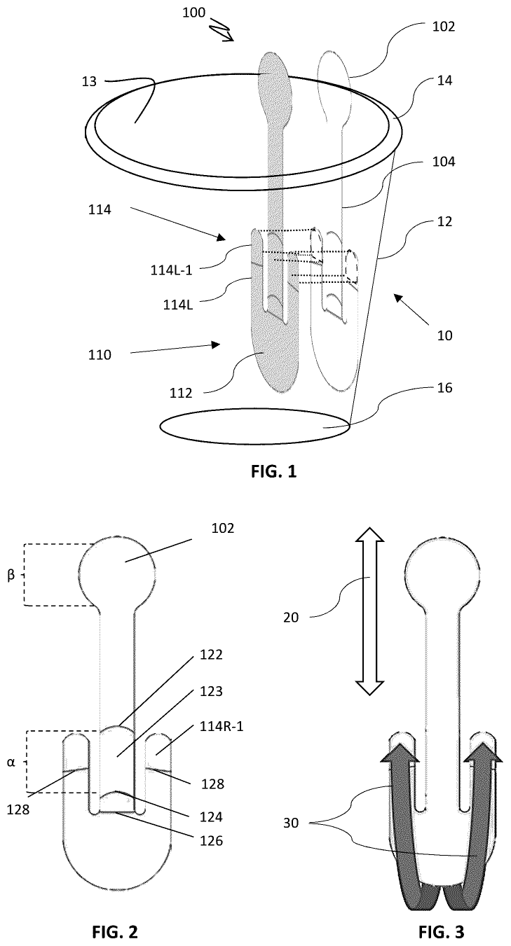

Referring now to the drawings, FIG. 1 illustrates a partial representation of a disposable cup 10 with an example embodiment of a stirrer (also referred to interchangeably as a “mixing device”) shown exploded away from the sidewall of the cup to which it is attached. FIG. 2 is a front view of the example embodiment of the stirrer. FIG. 3 illustrates the stirrer of FIGS. 1 and 2 with arrows indicating direction of movement of the stem and corresponding movement of the stirring portion (interchangeably referred to hereafter as “agitator”, “agitating member”, “agitating portion” and/or variations thereof).

A portion of disposable beverage cup 10 is shown in FIG. 1. The cup 10 includes a wall 12, in a form of a rolled foil which terminates at a lip 14 at the upper end of the wall, a bottom wall 16 which encloses the lower end of the wall, and a mixing/stirring device 100. A mixing device 100 is attached to the inner surface of the cup wall. The inner surface of the cup is waterproof. Paper cups are usually lined by a thin layer of hydrophobic film which is made of mostly plastic (polyethylene) and sometimes co-polymers to hold the liquid in the paper cup.

The mixing/stirring device 100 (shown in FIGS. 1, 2 and 3) includes a tab 102, a stem 104, an agitating portion 110 and an anchoring portion 114. In the example embodiment depicted in FIGS. 1-3, a pinchable/holdable tab/handle 102 is disposed at an upper end of the stem, or central section, 104. The agitating portion 110 is formed at a lower end of the stem. The stirrer is adhered to an inner/internal surface 13 of the wall 12 by one of various means of adhesion. The anchoring portion 114 refers to the part of the stirrer that is attached to the wall.

The agitating portion 110 includes a movable flap 112 and at least one shoulder portion 114. In the example embodiment depicted in FIGS. 1-3, the agitating portion 110 includes two shoulder portions 114L and 114R which extend upwards from the movable flap 112 on either side of the central section 104 of the stirrer 100. In the example embodiment, upper edges 114L-1 and 114R-1 of the shoulder portions 114 are adhered to the inner surface 13 of wall 12 and, as such, serve as the anchoring portion(s) of the stirrer.

The term “adhere” (and variations thereof) refers herein to adhering/adhesion including mechanical adhesion, heat sealing, ultrasonic welding or other methods that do not include providing an adhesive layer between the stirrer and the inner surface of the cup wall. In some cases, a non-removable adhesive layer may be applied between the anchoring portions and the inner wall of the cup. In such embodiments, attempting to remove the stirrer or actually succeeding in removing the stirrer would most likely result in the stirrer tearing, the lining of the inner wall tearing or both. (These embodiments are not to be confused with other embodiments detailed below where a specialized adhesive layer is added for the express purpose of the stirrer being detached from the inner wall, without damaging the inner wall or causing the stirrer to tear.)

Where the stem 104 meets the movable flap 112 there is a horizontal score line 126. The movable flap 112 swings hingedly away from the cup wall at the horizontal score line 126 when the stirrer is moved up and down (see FIG. 3). Each of the upper edges 114R-1, 114L-1 of shoulder portions 114 (114R, 114L) includes a slanted score line 128 which delineates each upper edge of each shoulder portion that is adhered to the wall from the rest of the shoulder portion.

While the tab, stem, agitating portion, and anchoring portion have been described separately, it is made clear that the stirrer may be cut (e.g., dye cut) as a single piece of material from a sheet of stock material. This feature is applicable to all the configurations and embodiments described herein.

FIG. 3 illustrates various arrows indicating a regular stirring activity. A movement arrow 20 indicates the vertical movement of the tab 102 and stem 104 which corresponds to the user's movement up and down whilst holding the tab 102. Moving the stirrer up and down, causes the agitating portion to agitate (or “stir”) the beverage. Two arrows 30 indicate the direction of movement of the agitation portion 110 as a result of the tab being moved vertically up and down.

Specifically, when the tab is moved down, the movable flap 112 and shoulder portions 114 move away from the wall. The flap 112 bends at the score line 126 (see FIG. 2) between the stem and the agitating portion and the shoulder portions bend at the score lines 128 (see FIG. 2).

The holdable tab 102 is adapted to jut out above the lip 14 of the wall 12 of the cup 10. In embodiments, the tab is sized and proportioned so as to fit through a drinking opening of a foldable lid (e.g., the foldable lid of a butterfly cup) or a disposable lid (not shown) when the lid is friction fit onto the lip 14 of the wall 12. The tab 102 is adapted to be held by two fingers (e.g., thumb and forefinger) of a user in a pincer grip and manipulated, at least, in a vertical direction, up and down.

The central section, or stem 104, of the stirrer 100 includes two score lines, an upper score line 122 and a lower score line 124. The lower score line is nearby, or proximate, the agitating portion 110. Each of the score lines forms a widthwise, convex/semi-circular indentation, spanning the width of the stem. The score lines 122, 124 are spaced apart from each other by a length a which is at least equal to a height β at which the holdable tab juts above the lip of the wall.

The spaced apart, curved score lines 122, 124 facilitate movement and transition between an unlocked state and a locked state of the stirrer. In the unlocked state the tab/handle juts above the lip of the wall. In the locked state, the tab is “locked” in a position whereby the top of the tab is below the lip of the wall. The stirrer moves or transitions between the unlocked state and the locked state (referred to also as a “pop lock”, on account of the popping sound/tactile feedback received when locking or unlocking the stem of the stirrer) upon receipt of downward vertical pressure (e.g., placed on the tab) which causes the central section/stem 104 to deform along the curved score lines 122, 124 until the section 123, between the curved score lines 122, 124, is folded beneath the movable flap 112.

Methods for producing the mixing device, stirrer, agitating apparatus according to this example embodiment, as well as all the other embodiments disclosed herein may be known in the art. One example of producing such a member is facilitated by pre-embossing the desired shape of the member, before cutting it out of a larger piece of the material from which the member is formed.

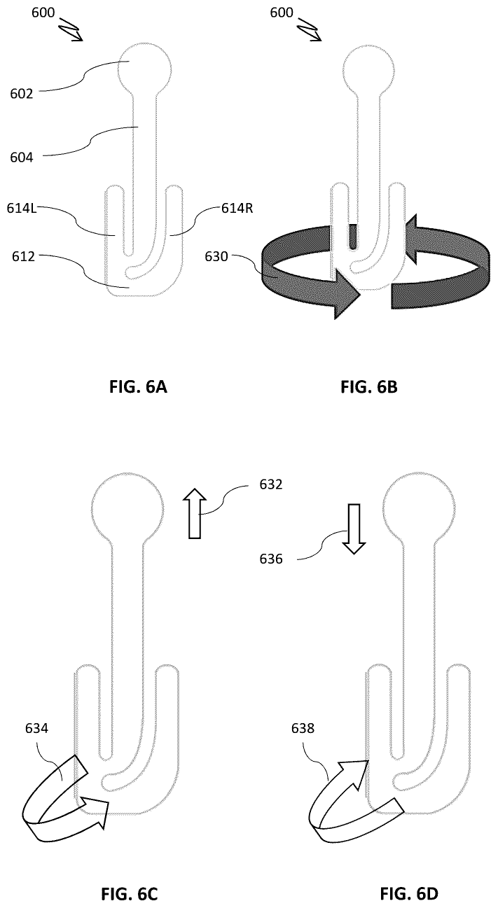

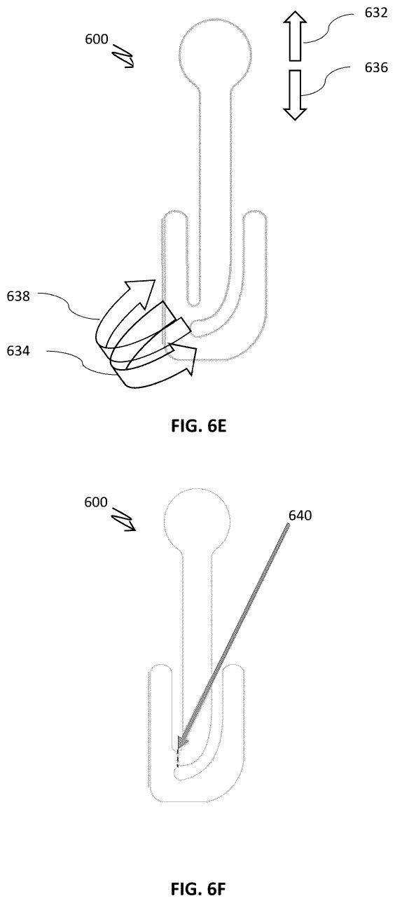

According to one optional method, before cutting the stirrer shape, a mandrill presses down the shape of the member that is to be cut. The contours and scoring lines are formed by applying different amounts of pressure to relevant areas of the larger piece of material. Even perforations (see for example FIG. 6C) can be formed in this manner. This method is relevant and can be used for any and all of the embodiments and configurations discussed herein.

In summary, the stirrer 100 is used regularly by moving the tab and stem up and down in the unlocked state. When finished stirring, the user uses the pop-lock feature to lock the stirrer by pushing the tab/stem down with sufficient force and to a sufficient degree that the stirrer transitions into the locked state where the tab is locked below the lip of the cup.

In the following sections, various examples, embodiments, configurations of fully or partially detachable stirring devices are detailed. In all of the following embodiments, there are discloses assemblies which each include, at least: a beverage cup and a mixing device/stirrer coupled to the cup. The disposable beverage cup includes a wall, in a form of a rolled foil, the wall terminating at a lip on an upper end thereof and a bottom wall enclosing a lower end thereof. The mixing device/stirrer is attached to an inner surface of the wall in such a manner that at least a portion of the mixing device adapted to be removed from the assembly without causing fibers to be deposited into a beverage disposed therein.

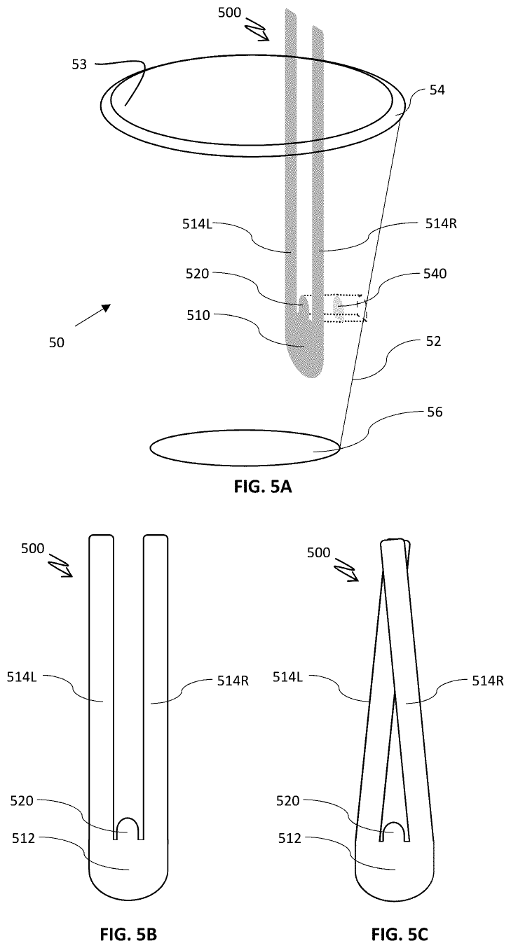

There are various degrees of detachment, which are detailed hereafter, but briefly mentioned now. In some cases, a portion of the mixing device, e.g., the tab and stem, is detached from the rest of the mixing device. In some cases, the term “at least a portion of the mixing device” refers to the entire mixing device (with or without the adhesive layer). In some of these cases (where the entire mixing device/stirrer is removed), the mixing device is removed prior to use (e.g., see FIGS. 5A-5C) and in other cases the mixing device is removed after use (e.g., see FIGS. 6A-7).

### Detachable Stirrer—Example 1

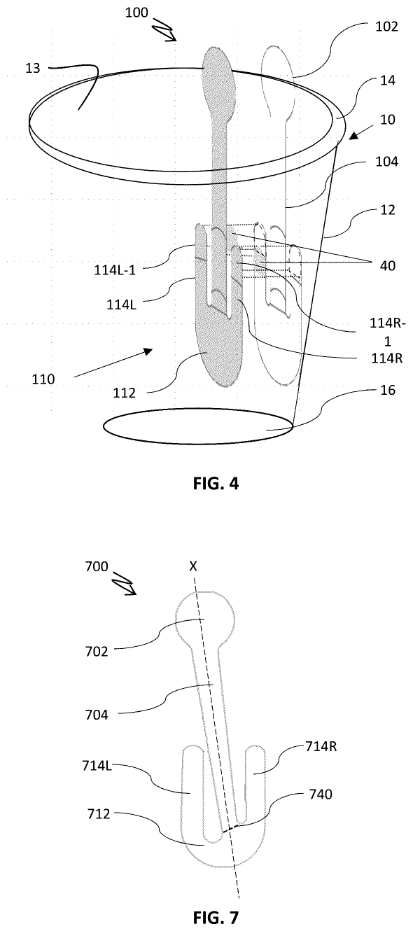

Another possible configuration is shown in FIG. 4. FIG. 4 depicts the same partial view of cup 10 and stirrer 100 as depicted in FIG. 1. The entire foregoing description of FIGS. 1-3 is to be seen as if repeated in its entirety here, except for the distinctions discussed hereafter.

Unlike the example embodiment of FIGS. 1-3, FIG. 4 depicts an example embodiment of a cup and stirrer assembly, where the stirrer 100 is adapted to be detachable from the cup 10. To facilitate the “detachable” feature, the example embodiment depicted in FIG. 4 differs from that of FIG. 1 in that there is provided a particular type of adhesive layer 40 between the anchoring portions (upper edges 114L-1 and 114R-1) of the stirrer 100 and the inner surface 13 of wall 12 of the cup 10. The adhesive layer allows for the stirrer to be detached from the wall of the cup without tearing the stirrer or cup wall, or otherwise harming the integrity of the waterproofing of the inner surface 13 of the wall. Furthermore, the adhesive layer is adapted such that when the stirrer is detached from the sidewall, no particulates are released from the wall or stirrer (that would otherwise be deposited in a beverage disposed in the cup).

The configuration of an assembly including a cup, an adhesive layer(s) and a stirrer/mixing device is not limited to the embodiment described above, but rather can be applied to any type of mixing device/stirrer that is attached to a disposable cup. By replacing the welding (or other coupling) process used in disposable cup known in the art with a layer of adhesive between the stirrer and inner surface 13 of the cup wall, the stirrer can be “detachable”, after fulfilling the stirring and/or mixing function. Any adhesive layer that allows for detachment of the stirrer without particulates breaking away from the stirrer/mixing device and/or wall is included within the scope of the definition of adhesive layer for a detachable stirrer/mixing device.

The layer of adhesive may be configured or adapted such that the adhesive layer remains attached to the inner wall when the stirrer is detached therefrom. For example, the side of the adhesive layer coupled to the inner wall may be adapted to bond with the inner wall in a non-detachable manner (i.e., forcing detachment would damage the inner lining/surface of the wall) while the outer side of the adhesive layer is adapted to couple with the mixing device/stirrer in a non-permanent manner, such that when a pulling force is applied to the stirrer (e.g., by a user) the stirrer detaches from the adhesive layer or particulates detaching from the stirrer. Alternatively, or additionally, the stirrer may be formed of a material (or treated with a treatment) that allows for the aforementioned coupling of the stirrer and adhesive layer without adhesive layer bonding with the stirrer in a permanent manner (i.e., in a manner whereby detaching the adhesive layer from the stirrer would cause damage to the surface of the stirrer).

Alternatively, when detaching the stirrer, the adhesive layer may be adapted to detach from the inner wall while remaining coupled to the stirrer. For example, the non-porous characteristic of the waterproof lining of the inner wall may allow the adhesive layer to temporarily couple/adhere to lining. The temporary coupling being decoupled under a predetermined pulling force applied (e.g., by a user) to the stirrer. Furthermore, decoupling/detaching the stirrer and/or adhesive layer does not ruin the non-porous nature of the waterproof lining of the inner wall.

Using a detachable stirrer includes the following steps: (1) fill the assembly of cup and detachable stirrer with a beverage; (2) mix/stir/agitate the beverage with the stirrer (with or without a lid fastened on the cup—the stirrer is configured to jut out through the drinking opening of the lid); (3) detach and discard the stirrer (if a lid was fixed onto the cup prior to the step of stirring, e.g., to prevent the beverage from sloshing during the stirring/while in motion, then the lid must be removed before the stirrer can be detached); and (4) drink the beverage (with or without a lid).

### Detachable Stirrer—Example 2

Another possible configuration is shown in FIGS. 5A, 5B and 5C. FIG. 5A depicts an example embodiment of a disposable cup assembly with a detachable stirrer. FIG. 5B depicts the stirrer 500 after being detached. FIG. 5C depicts stirrer 500 with arms placed together, where the tops of the arms overlap.

FIG. 5A depicts a partial view of a cup 50 and a stirrer 500. Cup 50 is a single-use, disposable cup having a wall 52, in a form of a rolled foil, the wall terminating at a lip 54 on an upper end thereof and a bottom 56 at a lower end thereof.

Stirrer 500 has an example U-shaped configuration, with elongated arms and an anchoring portion. Stirrer 500 includes an agitating portion 512 at the bottom of the U, linking the lower ends of the two elongated arms 514L and 514R together. In the example embodiment, an anchoring portion 520 is located above the agitating portion 512 and between the arms 514. Stirrer 500 is adhered to an inner surface 53 of a wall 52 of cup 50 at the anchoring portion 520.

An adhesive layer 540 is disposed between the anchoring portion 520 and the inner surface 53 of the sidewall 52. The adhesive layer 540 facilitates the “detachable” feature of the example stirrer. The adhesive layer allows for the stirrer to be detached from the wall of the cup without tearing the stirrer or the cup wall, or otherwise harming the integrity of the waterproofing of the inner surface 53 of the wall.

Any adhesive layer that allows for detachment of the stirrer without particulates breaking away from the stirrer/mixing device and/or wall is included within the scope of the definition of adhesive layer for a detachable stirrer/mixing device.

The layer of adhesive may be configured or adapted such that the adhesive layer remains attached to the inner wall when the stirrer is detached therefrom. For example, the side of the adhesive layer coupled to the inner wall may be adapted to bond with the inner wall in a non-detachable manner (i.e., forcing detachment would damage the inner lining/surface of the wall) while the outer side of the adhesive layer is adapted to couple with the mixing device/stirrer in a non-permanent manner, such that when a pulling force is applied to the stirrer (e.g., by a user) the stirrer detaches from the adhesive layer or particulates detaching from the stirrer. Alternatively, or additionally, the stirrer may be formed of a material (or treated with a treatment) that allows for the aforementioned coupling of the stirrer and adhesive layer without adhesive layer bonding with the stirrer in a permanent manner (i.e., in a manner whereby detaching the adhesive layer from the stirrer would cause damage to the surface of the stirrer).

Alternatively, when detaching the stirrer, the adhesive layer may be adapted to detach from the inner wall while remaining coupled to the stirrer. For example, the non-porous characteristic of the waterproof lining of the inner wall may allow the adhesive layer to temporarily couple/adhere to lining. The temporary coupling being decoupled under a predetermined pulling force applied (e.g., by a user) to the stirrer. Furthermore, decoupling/detaching the stirrer and/or adhesive layer does not ruin the non-porous nature of the waterproof lining of the inner wall.

Using the detachable stirrer 500 includes the following steps:
(1) Fill the disposable cup 50 including detachable stirrer 500 with a beverage.
(2) Detach stirrer 500 from the sidewall, e.g., by pulling the arms 514 of the stirrer 500 up and/or away from the sidewall 52. (Steps 1 and 2 can be reversed.)
(3) Hold the arms of the stirrer together, preferably by overlapping the free ends of the arms and pinching them together (e.g., in a pincer grip between the thumb and forefinger), as depicted in FIG. 5C.
(4) Stir the beverage with the stirrer 500 and discard the stirrer
(5) Optionally, a lid (not shown) can be folded or friction fit onto the lip of the cup.
(6) Drink the beverage.

### [Tear-Away Stem]

Yet another configuration is shown in FIGS. 6A-6F. FIG. 6A depicts a mixing device 600. Mixing device 600 is adapted to be attached or adhered to the inside surface of a wall of a disposable cup. The disposable cup would be similar to those known in the art and examples of which are illustrated in FIGS. 1, 4 and 5. The descriptions of the cups 10 and 50 regarding the sidewall, lip and bottom apply equally here and should be seen as if repeated here in full, mutatis mutandis.

Mixing device 600 is similar in configuration to stirring device 100. Mixing device 600 includes a tab 602, stem 604 and an agitating portion 610. The tab is located at the top of the stem and adapted for holding or pinching by a user, e.g., in a pincer grip between a thumb and forefinger of the user. The stem 604 descends vertically from the tab 602 and forms a 90-degree turn, at a bottom end of the stem, and couples with one of the arms of the agitating portion 610. The terminal end of the stem is approximately, or exactly, perpendicular to the vertical direction of the arm to which it is coupled or intimately formed.

The term “coupled”, as used in the previous paragraph, conveys the fact that the parts (stem and arm) are attached together. This attachment may be organic, i.e., both parts are formed/cut from the same substrate, or mechanically engineered, e.g., by attaching the parts together using some type of adhesive or method of adhesion.

The agitating portion 610 includes left support arm 614L and right support arm 614R and the connecting section, generally referred to as agitating flap 612. It is made clear that the invention is not limited to the exact design depicted in the figures, but rather to devices having similar functional parts.

In embodiments, both the support arms are adapted to be adhered [directly] to the inner surface of the sidewall of a single-use/disposable cup. The free ends of the arms are adapted (e.g., during manufacture/assembly) to be adhered (by any method known in the art, e.g., adhesive, ultrasonic welding, heat sealing, etc.) to the sidewall thereby anchoring the mixing device to the cup. The parts of the mixing device 600 that are not attached/adhered to the wall move when a user manipulates the tab (and therefore stem) of the device.

FIG. 6B illustrates arrows 630 which depict a general direction of fluid movement which is caused by a user manipulating the mixing device by moving the tab vertically, upwards and downwards. The off-center configuration of the stem (i.e., the fact that the end of the stem terminates at an off-center section of the agitating portion) causes that area/section of the agitating portion being pulled in an upwards direction (like pulling the corner of a piece of paper) to actually move diagonally (sidewards and upwards), causing the liquid in the cup to move in a generally sideways direction, which is indicated by arrows 630.

More Specifically, FIG. 6C depicts mixing device 600 with an upwards pointing arrow 632 indicating the direction the user moves the tab. Concurrently, the flap 612 is moved in the upwards diagonal direction indicated by arrow 634. FIG. 6D depicts mixing device 600 with a downwards pointing arrow 636 indicating the direction the user moves the tab. Concurrently, the flap 612 is moved in the downwards diagonal direction indicated by arrow 638, back to the flap's starting position. FIG. 6E depicts both the upwards and downwards direction of movement of the tab by the user and the resulting upward-diagonal and downward-diagonal movements of the flap 612. The resulting circular motion/movement of the fluid is indicated by arrows 630 (see FIG. 6B), as mentioned.

The circular momentum improves the agitation of the fluid in the cup. This is even achieved when manipulating the tab through the lid. The circular motion also reduces the chance of splashing, that might otherwise occur due to violent shaking of the tab. A similar off-center configuration shown in FIG. 7 has a similar enhanced capability of circular fluid motion.

In other embodiments, only one of the support arms is adapted to be adhered, at its upper edge, to the sidewall of the cup. In some embodiments it is the left arm 614L that is adapted to be adhered, at its upper edge, to the cup. In other embodiments it is the right arm 614R that is adapted to be adhered, at its upper edge, to the cup.

According to all embodiments of the configuration depicted in FIGS. 6A-6F, there is at least a portion of the mixing device that is adapted to be removed from the assembly of cup and mixing device 600, without causing particulates to be deposited into a beverage disposed therein.

To this end, in one embodiment, the meeting area between the bottom end of the stem 604 and the side of the left arm 614L is perforated or otherwise weakened in a manner which allows the stem to be detached from the mixing device without fibers or particulates, from either the arm or the stem, coming lose during the detachment process. FIG. 6F indicates an example of a perforation area 640 located at the meeting point between the stem and the arm. In other embodiments, the entire stirrer is adapted to be detached from the inner wall of the cup after use, in a similar manner to that of the embodiments related to example depicted in FIG. 4.

### Detachable Stirrer—Example 3

FIG. 7 depicts an example embodiment of a mixing apparatus, according to another configuration of the invention. FIG. 7 depicts a mixing apparatus 700 which has a general shape of a ship's anchor, similar to stirrers 100 and mixing apparatus 600. Mixing apparatus 700 includes a tab 702, stem 704 and agitating portion 710. Agitating portion 710 includes left and right support arms 714L and 714R and a connecting section, flap 712. It is made clear that the invention is not limited to the exact design depicted in the figures, but rather to devices having similar functional parts.

In embodiments, both the support arms are adapted to be adhered [directly] to the inner surface of the sidewall of a single-use/disposable cup. The free ends of the arms are adapted to be adhered to the sidewall thereby anchoring the mixing device to the up. The parts of the mixing apparatus 700 that are not attached/adhered to the wall move when a user manipulates the tab (and therefore stem) of the device.

In other embodiments, only one of the support arms is adapted to be adhered, at its upper edge, to the sidewall of the cup. In some embodiments it is the left arm 714L that is adapted to be adhered, at its upper edge, to the cup. In other embodiments it is the right arm 714R that is adapted to be adhered, at its upper edge, to the cup.

Stem 704 is disposed at an angle relative to the vertical orientations (and axes) of the support arms. The angle at which the stem is set may be any relevant angle whereby the stem does not overlap the arms. This parameter (non-overlapping parts of the stirrer) is dictated by the fact that the entire stirrer is cut (e.g., by a dye cutting machine) from a single piece of material (stock). As such, no section of the stem can overlap the either of the arms.

This stem is also referred to herein as a “diagonal stem” or “off-center stem”, on account of the [relatively] non-vertical orientation of the stem. While the term diagonal may, in some cases, refer to a 45-degree off-set angle, as used herein, the term is merely intended to indicate that the stem has neither a vertical nor horizontal axis.

The agitating section or flap 712 is shaped in such a manner that the lower end of the stem meets/terminates at a section of the flap that is approximately perpendicular to the axis X of the “diagonal” or “non-vertical” stem 704. It is made clear that the scope of the invention includes stems that are perpendicular as well as stems that are not perpendicular to the section of the flap where the stem meets the flap. The off-center placement of the stem relative to the agitating portion causes the circular agitation of the fluid in the cup, as detailed with respect to the embodiments of FIGS. 6A-E. Those details are to be seen as if fully set forth here, mutatis mutandis. According to all embodiments of the configuration depicted in FIG. 7, there is a portion of the mixing device that is adapted to be removed from the assembly of cup and mixing device 700, without causing particulates to be deposited into a beverage disposed therein.

To this end, the meeting area between the bottom end of the ‘diagonal’/off-center stem 704 and the flap 712 is perforated or otherwise weakened in a manner which allows the stem to be detached from the mixing device without fibers or particulates, from either the flap or the stem, coming lose during the detachment process. A perforation area 740 located at the meeting point between the stem and the flap. According to other embodiments, there is no perforated area, and the entire stirrer is adapted to be detached from the inner wall in a similar manner to the embodiments related to example assembly depicted in FIG. 4.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An assembly, comprising:
a disposable beverage cup, including: a wall, in a form of a rolled foil, the wall having a lip on an upper end thereof and a bottom wall enclosing a lower end thereof; and
a mixing device, attached to an inner surface of the wall;
wherein at least a portion of the mixing device adapted to be removed from the assembly without causing fibers to be deposited into a beverage disposed therein.

2. The assembly of claim 1, wherein an adhesive layer is disposed between an anchor portion or portions of the mixing device and the inner surface of the wall, the adhesive layer adapted for allowing the mixing device to be detached from the inner wall without damaging the mixing device or the inner wall.

3. The assembly of claim 2, wherein the inner wall has a waterproof lining, and the waterproof lining is not damaged when the mixing device is detached from the inner wall.

4. The assembly of claim 2, wherein the mixing device has a pop lock feature wherein a portion of a stem of the mixing device is adapted to deform when transitioning between an unlocked state and a locked state.

5. The assembly of claim 4, wherein the pop lock feature includes score lines provided on the stem proximal an agitating portion of the mixing device, the score lines including two widthwise, convex, semi-circular score lines spaced apart from each other, the score lines facilitating movement between the unlocked state and the locked state upon receipt of downward vertical pressure, wherein in the unlocked state the tab juts above the lip of the wall and in the locked state the stem deforms along the score lines such that the portion of the stem is disposed between the spaced apart score lines is folded behind the agitating portion of the mixing device located at a distal end of the mixing device.

6. The assembly of claim 2, wherein the mixing device is a U-shaped stirrer.

7. The assembly of claim 6, wherein the U-shaped stirrer includes two elongated arms and an agitating portion linking lower ends of the arms, free upper ends of the two elongated arms are adapted to be held together by a user and used to stir the beverage after being detached from the cup.

8. The assembly of claim 1, wherein the mixing device includes a tab, a stem, and an agitating portion and wherein the stem is adapted to be torn away from the agitating portion without fibers being deposited in the beverage.

9. The assembly of claim 8, wherein an axis of the stem is approximately perpendicular to a section of the agitating portion where the stem meets the agitating portion.

10. The assembly of claim 8, wherein the section of the agitating portion where the stem meets the agitating portion is perforated.

11. The assembly of claim 9, wherein the axis of the stem is at an off-set angle relative to vertical arms of the agitating portion.

12. The assembly of claim 1, wherein a stem of the mixing device terminates at an off-center section of an agitating portion of the mixing device, wherein manipulation of the stem causes the agitation portion to effect a circular movement of fluid disposed in the cup.

13. A disposable beverage cup, comprising:
a wall, in a form of a rolled foil, the wall having a lip on an upper end thereof and a bottom wall enclosing a lower end of the wall; and
a mixing device, said mixing device comprising:
a stem having a tab disposed at an upper end thereof and an agitating portion disposed at a lower end thereof, the stem having an unlocked state wherein the tab juts out above the lip of the wall and a locked state wherein the tab does not jut out above the lip, wherein a portion of the stem is adapted to deform when transitioning between the unlocked state and the locked state upon receipt of a downward vertical pressure on the stem.

14. The disposable cup of claim 13, wherein score lines are provided on the stem, proximal the agitating portion, the score lines including two widthwise, convex, semi-circular score lines spaced apart from each other;
wherein the portion of the stem is adapted to deform along the score lines when transitioning between the unlocked state and the locked state.

15. The disposable cup of claim 13, wherein the tab is adapted to fit through a drinking opening of a foldable lid or a disposable lid when the disposable lid is friction fitted on the lip of the wall.

16. The disposable cup of claim 13, wherein the agitating portion comprises: a movable flap and at least one shoulder portion extending upwards from the movable flap, each of the at least one shoulder portion having an upper edge thereof adhered to the wall.

17. The disposable cup of claim 16, wherein the at least one shoulder portion includes two shoulder portions extending upwards from the movable flap on either side of the stem, and wherein upper edges of the two shoulder portions are adhered to the wall.

18. The disposable cup of claim 13, wherein a section defined between the score lines folds behind the movable flap when transitioning between the unlocked state and the locked state.

19. The disposable cup of claim 18, wherein the section defined between the score lines has a length at least equal to a height at which the tab juts out above the wall.

20. The disposable cup of claim 14, further including a horizontal score line between the central section and the movable flap.
